(19) United States
(12) Patent Application Publication
(10) Pub. No.: US 2007/0129105 A1
(43) Pub. Date: Jun. 7, 2007

(54) MOBILE COMMUNICATION DEVICE PROVIDED WITH AN EAR TEMPERATURE SENSOR

(76) Inventor: Ein-Yiao Shen, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 11/164,735

(22) Filed: Dec. 2, 2005

(51) Int. Cl. H04M 1/00

(52) U.S. Cl. 455/556.1

(57) ABSTRACT

A mobile communication device provided with an ear temperature sensor comprises a mobile communication device comprising an ear temperature sensor and a measuring key installed thereon, said measuring key enabling said ear temperature sensor to detect an ear temperature, then presenting said ear temperature directly on a display of said mobile communication devic. By using said mobile communication device provided with said ear temperature sensor, a user can detect the ear temperature immediately and provide display, alert, storage and communication functions.

### BACKGROUND OF THE INVENTION

1. Field of the invention

The present invention relates to a mobile communication device provided with an ear temperature sensor and more particularly to a mobile communication device combining ear temperature sensing capability provided by a thermometer or an ear thermometer to immediately detect ear temperature.

2. DESCRIPTION OF THE PRIOR ART

Recently, the uprising alert of avian influenza (H5N1) has reminded people of the Severe Acute Respiratory Syndrome (SARS) that devastated Taiwan several years ago. According to the Department of Infectious Diseases of the National Taiwan University Hospital, avian influenza is more contagious than SARS, with its death rate approaching ten times of that of SARS. However, according to National Health Research Institutes of Taiwan, though the death rate of avian influenza is decreasing, it also means that the H5N1 virus will stay inside virus carriers to trigger widespread outbreaks. Since the SARS outbreak has taken away 84 lives with its death rate approaching ten percent, once the avian influenza emerges, people tend to be cautious, partly due to the uncertainty of avian influenza and its high contagious capability even before patients show any symptoms. Basically, people infected with SARS or avian influenza through breathing have similar symptoms such as fever, cough, pneumonia and respiratory failure at the beginning, making it difficult to diagnose and apply any treatment in the early stage. Besides, avian influenza is highly contagious, once it is transmitted to human, fast human-to-human transmission will be a disaster for humankind. Therefore, the government and medical institutes strongly recommend that people visiting Southeast Asia should be cautious about any symptoms related to avian influenza.

Therefore, it is vital to use a thermometer or ear temperature sensor to detect body temperature to find out if a person is having a fever. However, the lack of convenient ways to detect temperature immediately has been an obstacle in monitoring one's own temperature. Hence the inventor proposes a mobile communication device provided with a temperature sensor to detect temperature at any time, in any place.

Besides, please refer to issued US patent and published application publications by the same inventor, among which are 1. U.S. Pat. No. 6,428,475 “Mobile phone combined physiological function detector”, 2. U.S. patent application publication No. 2004-0229661 A1 “Cellular phone combined physiological condition examination and processing device”, 3. U.S. patent application publication No. 2004-0111013 A1 “Personal life information managing system”, 4. U.S. patent application publication No. 2005-0083194 A1 “Wireless vital signs transmission device in a physiological detector”, and 5. U.S. patent application publication No. 2005-0177029 A1 “Earphone-type physiological function detecting system”.

Therefore, previous temperature detecting methods mentioned above present several shortcomings which must be overcome for them to be more user-friendly, convenient and popular.

In view of the above-described deficiency of prior-art thermometers, after years of constant effort in research, the inventor of this invention has consequently developed and proposed a mobile communication device provided with an ear temperature sensor in the present invention.

### SUMMARY OF THE INVENTION

It is an object of the present invention to provide a mobile communication device combining ear temperature sensing capability provided by a thermometer or an ear thermometer to immediately detect ear temperature.

The present invention discloses a mobile communication device provided with an ear temperature sensor, comprising a mobile communication device and an ear temperature sensor installed thereon. There are many ways, such as fixed type, sliding type, pin type, pivotal rotation type, or wirelessly transmitted detecting pen type of methods to install the ear temperature sensor on the mobile communication device. Furthermore, a measuring key, which is replaceable by any key on the mobile communication device, is suitably installed on the mobile communication device. A user can enable the ear temperature sensor by way of the measuring key to detect an ear temperature, then presenting the ear temperature directly on a display of the mobile communication device. By using the mobile communication device provided with an ear temperature sensor comprising the mobile communication device, the ear temperature sensor, the measuring key and the display, a user can detect ear temperature immediately without limitation to determine if he/she is having a fever, then use the mobile communication device to provide display, alert, storage and communication functions.

These features and advantages of the present invention will be fully understood and appreciated from the following detailed description and the accompanying Drawings.

### BRIEF DESCRIPTION OF THE DRAWINGS

FIG. 1 illustrates a diagram of a mobile communication device provided with an ear temperature sensor in the present invention;

FIG. 2 illustrates an embodiment of the mobile communication device provided with an ear temperature sensor in the present invention;

FIG. 3A and B illustrate another embodiment of the mobile communication device provided with an ear temperature sensor in the present invention;

FIG. 4A and B illustrate still another embodiment of the mobile communication device provided with an ear temperature sensor in the present invention;

FIG. 5A and B illustrate still another embodiment of the mobile communication device provided with an ear temperature sensor in the present invention;

FIG. 6 illustrates still another embodiment of the mobile communication device provided with an ear temperature sensor in the present invention; and

FIG. 7 illustrates still another embodiment of the mobile communication device provided with an ear temperature sensor in the present invention.

### DETAILED DESCRIPTION OF THE PREFERRED EMBODIMENT

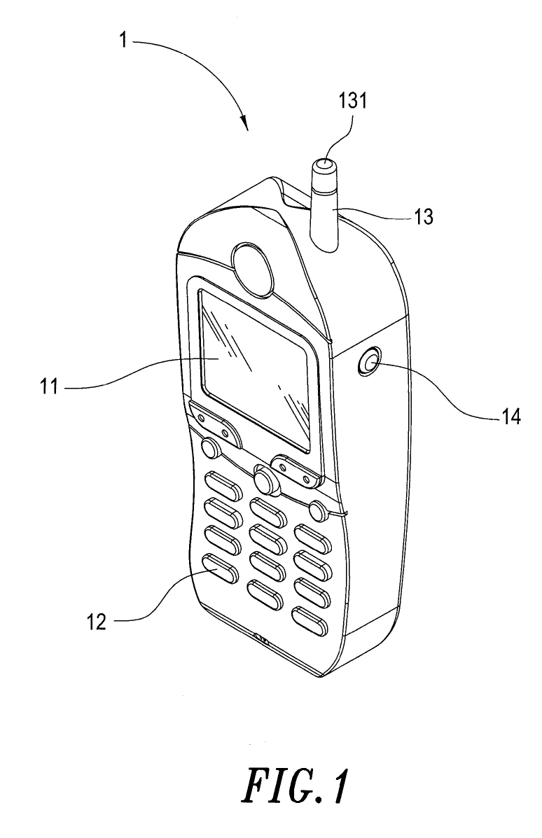

Please refer to FIG. 1 for a mobile communication device provided with an ear temperature sensor in the present invention, comprising:

A mobile communication device 1, the mobile communication device 1 comprising a display 11 and keys 12, a measuring device 13 suitably fixed to the mobile communication device 1, an ear temperature sensor 131 formed on a tip of the measuring device 13 to detect the ear temperature of a human body, and a measuring key 14 suitably installed at the mobile communication device 1 for enabling the ear temperature sensor 131 to start to detect the ear temperature;

The mobile communication device 1 can be a mobile phone or a personal digital assistant (PDA); the measuring device 13 can be an infrared-based, electronic-detection-based, biochip-based, or other types of sensor devices; and the measuring key 14 is replaceable by any key 12 installed on the mobile communication device 1.

The inventor supposes that nearly everyone possesses a certain kind of mobile communication device such as a mobile communication device 1, therefore, by using the mobile communication device provided with an ear temperature sensor mentioned above, a user can detect his/her ear temperature immediately.

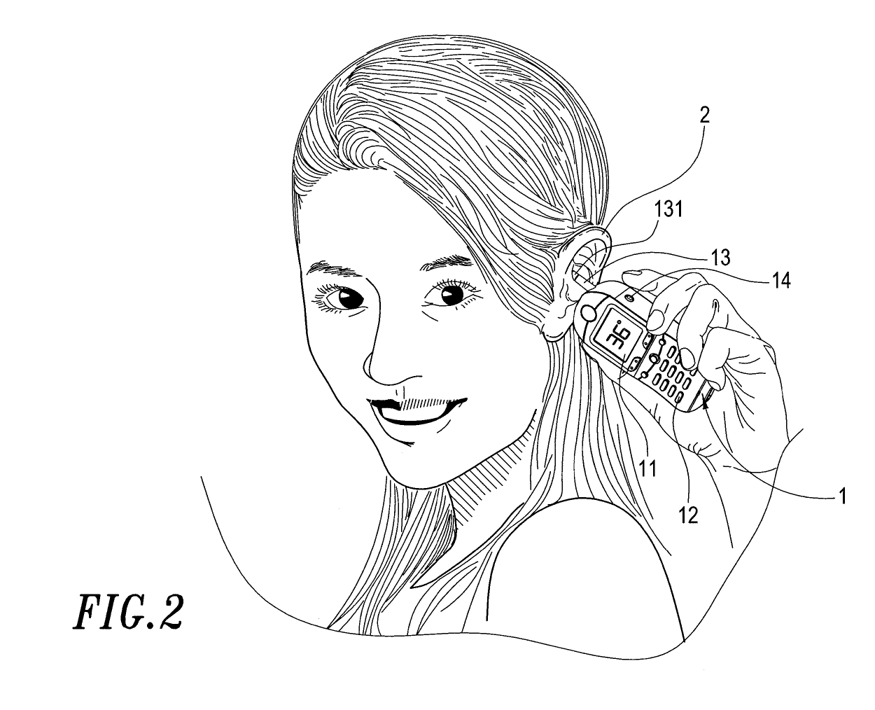

Besides, please refer to FIG. 2, a user only needs to stick the measuring device 13 of the mobile communication device 1 into an ear canal 2, then press the measuring key 14 to detect the ear temperature by using the ear temperature sensor 131 of the measuring device 13, then the ear temperature will be presented on the display 11 of the mobile communication device 1. The user can directly read the temperature presented on the display 11 without any other tool to determine if he/she is having a fever, and use the mobile communication device 1 to provide display, alert, storage and communication functions.

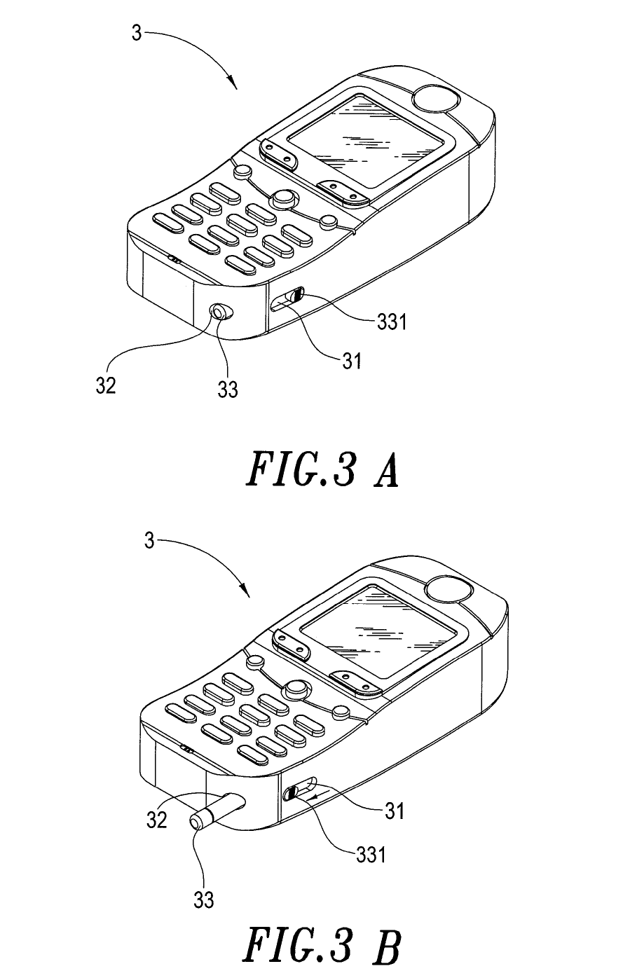

FIG. 3A and B illustrate another embodiment of the mobile communication device provided with an ear temperature sensor in the present invention. In both figures, a sliding slot 31 and an opening 32 are formed suitably on one side of the mobile communication device 3 and connected through each other, with an ear temperature sensor 33 formed inside the sliding slot 31 and a push button 331 extending from one side of the ear temperature sensor 33 to protrude outside of the sliding slot 31; to detect ear temperature, the user can push the push button 331 towards the opening 32, then stick the ear temperature sensor 33 to protrude outside of the opening 32 to let the ear temperature sensor 33 stick into an ear canal 2, then press the measuring key 14 or any key 12 to detect the ear temperature and present the ear temperature on the display 11.

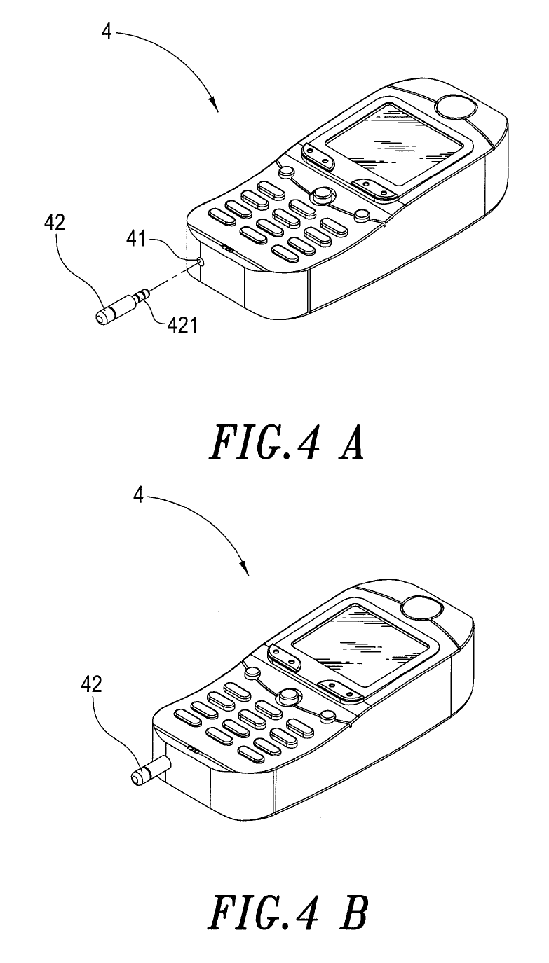

FIG. 4A and B illustrate still another embodiment of the mobile communication device provided with an ear temperature sensor in the present invention. In both figures, a jack 41 is suitably formed at one side of the mobile communication device 4; besides, one end of an ear temperature sensor 42 is a pin 421 for sticking into the jack 41 of the mobile communication device 4. To detect ear temperature, the user sticks the ear temperature sensor 42 into an ear canal, then presses a measuring key or any key to detect the ear temperature and present the ear temperature on the display 11.

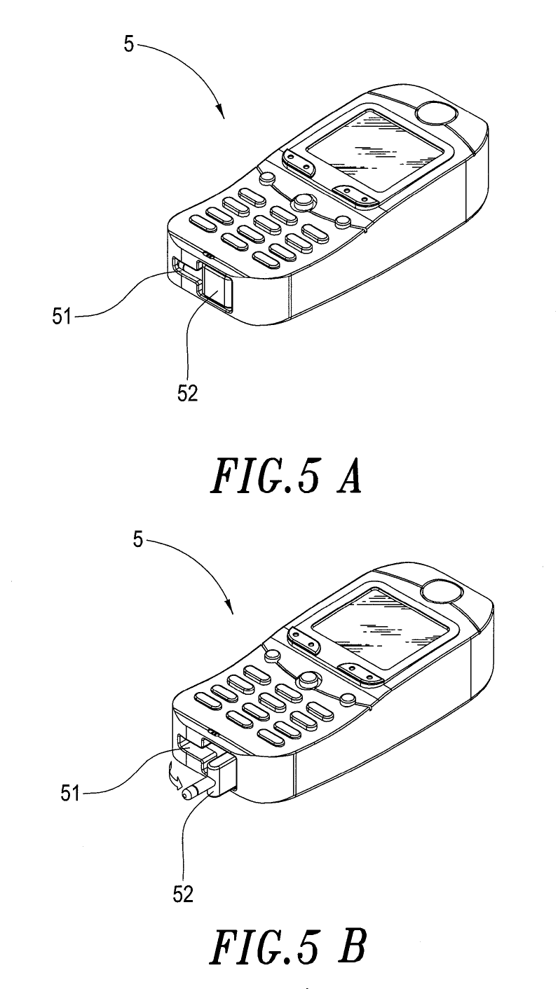

FIG. 5A and B illustrate still another embodiment of the mobile communication device provided with an ear temperature sensor in the present invention. In both figures, a groove 51 is suitably formed at one side of the mobile communication device 5, with an ear temperature sensor 52 pivotally connected inside the groove 51; to detect ear temperature, the user rotates the ear temperature sensor 52 outwards to rest outside of the groove 51, then presses a measuring key or any key to detect the ear temperature and present the ear temperature on the display; after that, the ear temperature sensor 52 can be rotated inwards to be placed inside the groove 51. Thus, it is easy and convenient to operate the device.

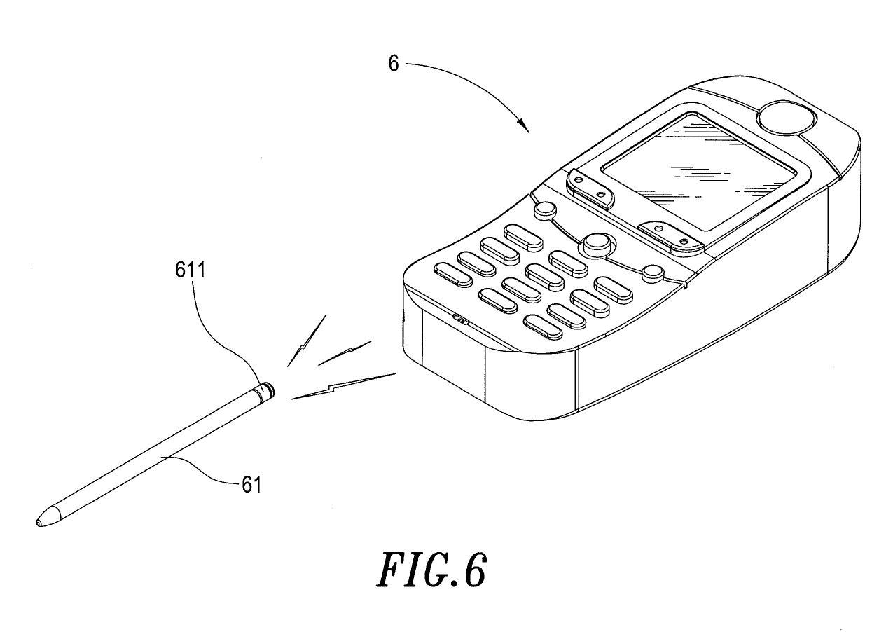

FIG. 6 illustrates still another embodiment of the mobile communication device provided with an ear temperature sensor in the present invention. In this figure, a mobile communication device 6 possesses an integrated wireless transmission capability; furthermore, a tip of a detecting pen 61 combining an ear temperature sensor 611, which also possesses an integrated wireless transmission capability; when a user presses a measuring key or any key to detect an ear temperature signal, the ear temperature sensor 611 will transmit the ear temperature signal wirelessly to the mobile communication device 6 for presenting the received signal on the display.

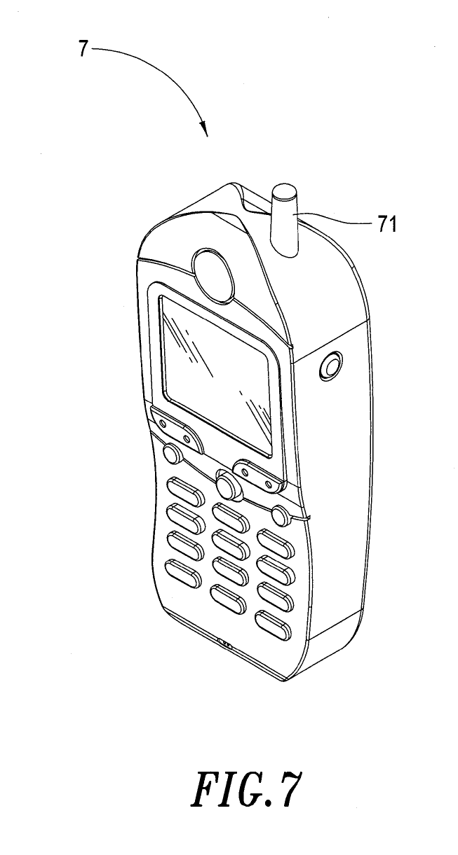

FIG. 7 illustrates still another embodiment of the mobile communication device provided with an ear temperature sensor in the present invention. In this figure, an ear temperature sensor 71 installed on one side of the mobile communication device 7 extends out thereof. In order to detect ear temperature, one sticks the ear temperature sensor 71 into an ear canal, then presses the measuring key or any key to detect the ear temperature and present the ear temperature on the display.

The present invention provides a mobile communication device provided with an ear temperature sensor, which, when compared with other prior art temperature detection devices, is advantageous as described in the following:

1. The present invention provides a mobile communication device combining ear temperature sensing capability provided by a thermometer or an ear thermometer. A user can stick the ear temperature sensor into an ear canal to immediately detect the ear temperature, without being limited to basic temperature detecting methods.

2. The present invention discloses a mobile communication device provided with an ear temperature sensor. There are many ways, such as fixed type, sliding type, pin type, pivotal rotation type, or wireless transmission detecting pen type of methods for installing the ear temperature sensor on the mobile communication device. Users can choose a suitable type based on their needs.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A mobile communication device provided with an ear temperature sensor, comprising:
a mobile communication device, said mobile communication device comprising a display and a plurality of keys;
a measuring device suitably fixed to said mobile communication device, which has an ear temperature sensor formed on a tip thereof; and
a measuring key suitably installed on said mobile communication device for enabling said ear temperature sensor to start to detect ear temperature,
whereby ear temperature can be monitored by sticking said measuring device into an ear canal of a user, then pressing said measuring key to detect an ear temperature of said user by using said ear temperature sensor of said measuring device, and then presenting said ear temperature on said display of said mobile communication device.

2. The mobile communication device provided with an ear temperature sensor of claim 1, wherein said mobile communication device is a mobile phone or a personal digital assistant (PDA).

3. The mobile communication device provided with an ear temperature sensor of claim 1, wherein said measuring device is infrared-based, electronic-detection-based, or biochip-based.

4. The mobile communication device provided with an ear temperature sensor of claim 1, wherein said measuring key is replaceable by any key of said mobile communication device.

5. A mobile communication device provided with an ear temperature sensor, comprising:
a mobile communication device, said mobile communication device comprising a display, a plurality of keys, and a fixed antenna;
an ear temperature sensor formed on a tip of said antenna; and
a measuring key suitably installed on said mobile communication device for enabling said ear temperature sensor to start to detect ear temperature,
whereby ear temperature can be monitored by sticking said ear temperature sensor on said tip of said antenna into an ear canal of a user, then pressing said measuring key to detect an ear temperature of said user by using said ear temperature sensor on said tip of said antenna, and then presenting said ear temperature on said display of said mobile communication device.

6. The mobile communication device provided with an ear temperature sensor of claim 5, wherein said mobile communication device is a mobile phone or a personal digital assistant (PDA).

7. The mobile communication device provided with an ear temperature sensor of claim 5, wherein said measuring key is replaceable by any key of said mobile communication device.

8. A mobile communication device provided with an ear temperature sensor, comprising:
a mobile communication device, said mobile communication device comprising a display and a plurality of keys;
a sliding slot and an opening formed suitably on one side of said mobile communication device and connected through each other;
an ear temperature sensor formed inside said sliding slot; and
a push button extending from one side of said ear temperature sensor to protrude outside of said sliding slot,
whereby ear temperature can be monitored by pushing said push button towards said opening to enable said ear temperature sensor to go back and forth inside said sliding slot, then moving said ear temperature sensor to protrude outside of said opening to let said ear temperature sensor stick into an ear canal of a user, then pressing said measuring key to detect an ear temperature of said user, and then presenting said ear temperature on said display of said mobile communication device.

9. The mobile communication device provided with an ear temperature sensor of claim 8, wherein said mobile communication device is a mobile phone or a personal digital assistant (PDA).

10. The mobile communication device provided with an ear temperature sensor of claim 8, wherein said measuring key is replaceable by any key of said mobile communication device.

11. A mobile communication device provided with an ear temperature sensor, comprising:
a mobile communication device, said mobile communication device comprising a display, a plurality of keys, and a jack suitably formed at one side thereof; and
an ear temperature sensor, one end of which is a pin for sticking into said jack of said mobile communication device,
whereby ear temperature can be monitored by sticking said ear temperature sensor into an ear canal of a user, then pressing a measuring key to detect an ear temperature of said user, and then presenting said ear temperature on said display.

12. The mobile communication device provided with an ear temperature sensor of claim 11, wherein said mobile communication device is a mobile phone or a personal digital assistant (PDA).

13. The mobile communication device provided with an ear temperature sensor of claim 11, wherein said measuring key is replaceable by any key of said mobile communication device.

14. A mobile communication device provided with an ear temperature sensor, comprising:
a mobile communication device, said mobile communication device comprising a display and a plurality of keys, wherein said mobile communication device further comprises a groove suitably formed at one side thereof, with an ear temperature sensor pivotally connected inside said groove,
whereby ear temperature can be monitored by rotating said ear temperature sensor to rest outside of said groove, then sticking said ear temperature sensor into an ear canal of a user, then pressing a measuring key to detect an ear temperature of said user, and then presenting said ear temperature on said display.

15. The mobile communication device provided with an ear temperature sensor of claim 14, wherein said mobile communication device is a mobile phone or a personal digital assistant (PDA).

16. The mobile communication device provided with an ear temperature sensor of claim 14, wherein said measuring key is replaceable by any key of said mobile communication device.

17. A mobile communication device provided with an ear temperature sensor, comprising:
a mobile communication device, said mobile communication device comprising a display and a plurality of keys, wherein said mobile communication device possesses an integrated wireless transmission capability; and
a detecting pen, a tip of said detecting pen combining an ear temperature sensor, which also possesses an integrated wireless transmission capability,
whereby ear temperature can be monitored by sticking said ear temperature sensor into an ear canal of a user, then pressing a measuring key to detect an ear temperature signal, and making said ear temperature sensor transmit said ear temperature signal wirelessly to said mobile communication device for presenting said signal received by said mobile communication device on said display.

18. The mobile communication device provided with an ear temperature sensor of claim 17, wherein said mobile communication device is a mobile phone or a personal digital assistant (PDA).

19. The mobile communication device provided with an ear temperature sensor of claim 17, wherein said measuring key is replaceable by any key of said mobile communication device.

20. A mobile communication device provided with an ear temperature sensor, comprising:
a mobile communication device, said mobile communication device comprising a display, a plurality of keys, and an ear temperature sensor extending out of said mobile communication device, and
a measuring key suitably installed on said mobile communication device for enabling said ear temperature sensor to start to detect ear temperature,
whereby ear temperature can be monitored by sticking said ear temperature sensor into an ear canal of a user, then pressing said measuring key to detect an ear temperature of said user by using said ear temperature sensor, and then presenting said ear temperature on said display of said mobile communication device.

21. The mobile communication device provided with an ear temperature sensor of claim 20, wherein said mobile communication device is a mobile phone or a personal digital assistant (PDA).

22. The mobile communication device provided with an ear temperature sensor of claim 20, wherein said measuring key is replaceable by any key of said mobile communication device.
